(19) United States
(12) Patent Application Publication
(10) Pub. No.: US 2008/0238946 A1
(43) Pub. Date: Oct. 2, 2008

(54) SYSTEM AND METHOD FOR PROVIDING A REPLICA OF A GRAPHIC PRESENTATION

(75) Inventor: Jason R. Baughman, Lakewood, CA (US)

Correspondence Address: LAW OFFICE OF DONALD D. MONDUL, 3060 BONSAI DRIVE, PLANO, TX, 75093, US

(73) Assignee: BOEING COMPANY A CORP. OF DELAWARE, Chicago, IL (US)

(21) Appl. No.: 11/693,002

(22) Filed: Mar. 29, 2007

(51) Int. Cl. G09G 5/00

(52) U.S. Cl. 345/661

(57) ABSTRACT

A system providing a graphic presentation replica of an original graphic presentation represented by an original graphic data set established by an originator employing a first graphic instruction set includes: (a) a data extractor accessing the original data set to generate validation data defining validation parameters for evaluating the graphic presentation replica; and (b) a neutral export unit accessing the original data set to generate neutral model data usable by a second graphic instruction set. A receiver is coupled with the data extractor and the neutral import unit for receiving the validation data and the neutral model data. The receiver employs the validation data and the neutral model data for generating a translated graphic data set to establish the graphic presentation replica employing the second graphic instruction set. The graphic presentation replica is sufficiently similar with the original graphic presentation to satisfy at least one validation parameter.

### TECHNICAL FIELD

The disclosure may be directed to computer graphic systems generating graphic presentations in data files that may be exported or otherwise shared among users. In particular, the disclosure may be directed to Computer Aided Design (CAD) systems generating multi-dimensional models in data files that may be exported or otherwise shared among users. By way of example and not by way of limitation, multi-dimensional models may include two-dimensional drawings or three-dimensional drawings.

### BACKGROUND

There are many different computer graphic programs, such as by way of example and not by way of limitation CAD systems, used in industry today. Various entities may find a need to share three-dimensional models generated or produced by computer graphic programs such as, by way of example and not by way of limitation, suppliers sharing with a customer, sharing among corporate partners, sharing among joint venturers and sharing among different divisions within a particular corporate entity. Various users may employ different graphic program systems at different entities. As a result, it may be necessary to perform conversions or data translations involving graphic data in order to share data among users with sufficient accuracy to permit production of copy or replica three-dimensional manufacturing information at various entities. Such copying of three-dimensional models and other graphic presentations is useful when various entities need to cooperate, such as in product development, product testing or other activities.

Verification of accuracy of three-dimensional models copies may be effected, by way of example and not by way of limitation, by assuring adherence to tolerances or other verification criteria in replica or copy three-dimensional models. Edge definitions or, by way of further example and not by way of limitation, verification parameters may include required adherence by a replica model with defined aspects of an original model such as particular reference points or edges, particular axes, moments of inertia axes, location of center of gravity of a three dimensional figure represented by a CAD model, or other parameters or a combination of parameters. Checking such verification parameters in replica model may be difficult or expensive to carry out.

Graphic systems such as CAD systems may incorporate algorithms or other treatments for generating neutral geometric files to facilitate interoperability among various graphic systems. One example of such a neutral file is a STEP file. A STEP file may be a file related with ISO Standard 10303 (ISO: International Organization for Standardization, based in Geneva). STEP may also be referred to as the Standard for the Exchange of Product Model Data. STEP is an international standard for computer-interpretable representation and exchange of industrial product data. STEP files are substantially neutral in that they may be used, by way of example and not by way of limitation, to exchange CAD (Computer Aided Design), CAM (Computer Aided Manufacture), CAE (Computer Aided Engineering) and other computer-interpretable files. However, neutral files, such as STEP files, do not necessarily contain sufficient information for accurate verification of exchanged files.

The cost of a system or process to overcome the lack of verification of exchanged drawings or models resulting from neutral files can be prohibitive. The prohibitive character of the problem may be particularly acute when one considers that there are a significant number and variety of different computer-interpretable graphic systems that should be accommodated.

There are tools capable of performing file-to-file comparisons and thereby effect a sort of verification. However, such tools generally only compare an original data file with a standard “meta-file” (e.g., a STEP file) that is generated. No original-model-to-replica-model comparison is made. That is, no source-to-replica comparison is made. A source-to-replica comparison may be made with a comparison tool such as, by way of example and not by way of limitation, Mirror Model Comparator (MMC) program sold by Translation Technologies Incorporated. However, such an MMC comparison requires a user to have both the source-generating and the replica-generating computer-interpretable graphic systems or programs available for the comparison. Again, the significant number and variety of different computer-interpretable graphic systems that should be accommodated makes such a “one-to-one” solution as an MMC-based solution cost-prohibitive. Such a “one-to-one” solution would require a different converted data package for each respective target computer-interpretable graphic system, an expensive and maybe cost-prohibitive solution.

Using a data file for a replica of a drawing or model which has not been verified vis-á-vis an original drawing or model may cause a user of the replica drawing or model to fail to meet engineering requirements. Failing to meet engineering requirements may be manifested, by way of example and not by way of limitation, in a failure to meet tolerances required for proper operation by a device manufactured according to the replica drawing or model.

There is a need for a system and method for providing a replica of a graphic presentation, such as a three-dimensional model, which can automatically perform verification of the conversion between computer-interpretable graphic systems producing an original model and producing a replica model.

There is a need for a system and method for providing a replica of a graphic presentation that can prevent use of a replica model that does not satisfy predetermined verification parameters.

### SUMMARY

A system providing a graphic presentation replica of an original graphic presentation represented by an original graphic data set established by an originator employing a first graphic instruction set includes: (a) a data extractor accessing the original data set to generate validation data defining validation parameters for evaluating the graphic presentation replica; and (b) a neutral export unit accessing the original data set to generate neutral model data usable by a second graphic instruction set. A receiver is coupled with the data extractor and the neutral import unit for receiving the validation data and the neutral model data. The receiver employs the validation data and the neutral model data for generating a translated graphic data set to establish the graphic presentation replica employing the second graphic instruction set. The graphic presentation replica is sufficiently similar with the original graphic presentation to satisfy validation parameters.

A method for providing a graphic presentation replica of an original graphic presentation represented by an original graphic data set, and established by an originator employing the original graphic data set with a first graphic instruction set, includes: (a) in no particular order: (1) providing a data extracting unit coupled for accessing the original graphic data set; (2) providing a neutral export treatment unit coupled for accessing the original graphic data set; and (3) coupling the receiver with the data extracting unit and with the neutral export treatment unit. The method continues with, (b) in no particular order: (1) operating the data extracting unit to generate validation data defining at least one validation parameter for evaluating whether to accept at least one difference between the original graphic presentation and the graphic presentation replica; and (2) operating the neutral export treatment unit to generate neutral model data relating to the original graphic presentation. The neutral model data is expressed in neutral terminology usable by a second graphic instruction set. The method continues with (c) operating the receiver to receive the validation data and the neutral model data; and (d) employing the receiver to use the validation data and the neutral model data with the second graphic instruction set for generating the graphic presentation replica; the graphic presentation replica being substantially sufficiently similar with the original graphic presentation to satisfy at least one validation parameter of the at least one validation parameter.

It is, therefore, a feature of the disclosure to provide a system and method for providing a replica of a graphic presentation, such as a three-dimensional model, which can automatically perform verification of the conversion between computer-interpretable graphic systems producing an original model and producing a replica model.

It is a further feature of the disclosure to provide a system and method for providing a replica of a graphic presentation that can prevent use of a replica model or product definition that does not satisfy predetermined verification parameters.

Further features of the disclosure will be apparent from the following specification and claims when considered in connection with the accompanying drawings, in which like elements are labeled using like reference numerals in the various figures, illustrating the preferred embodiments of the disclosure.

### BRIEF DESCRIPTION OF THE DRAWINGS

FIG. 1 is a schematic of a writer unit configured for use with embodiments of the system of the disclosure.

FIG. 2 is a schematic of a reader unit configured for use with embodiments of the system of the disclosure.

FIG. 3 is a schematic of a writer unit and a reader unit configured for use in troubleshooting embodiments of the system of the disclosure.

FIG. 4 is a flow diagram illustrating an embodiment of the method of the disclosure.

### DETAILED DESCRIPTION

An embodiment of the disclosure may be a method and system for verification and enforcement of design data among different computer-interpretable graphic systems, such as by way of example and not by way of limitation, different CAD system platforms. Computer-interpretable graphic systems may be referred to hereinafter simply as CAD systems in order to simplify this description.

In its preferred embodiment, the system may include a “writer” unit and a “reader” unit. The writer unit may load a source or original CAD file into a source or original CAD system, generate neutral geometric data from the source CAD system, generate a validation data establishing at least one validation parameter, and output or present a packaged or combined data file containing both neutral geometric data and validation data. The reader unit may unpack the packaged data file, load the neutral geometric data into a target or replica CAD system and verify the target or replica model using the validation data (also unpacked from the packaged data file). If the target or replica model does not meet the verification parameter or parameters or does not meet user-specified criteria, a user at the target CAD system may be prevented from accessing the target model. The validation data may be accessed by a user to include the user-specified criteria as a part of the validation data if desired.

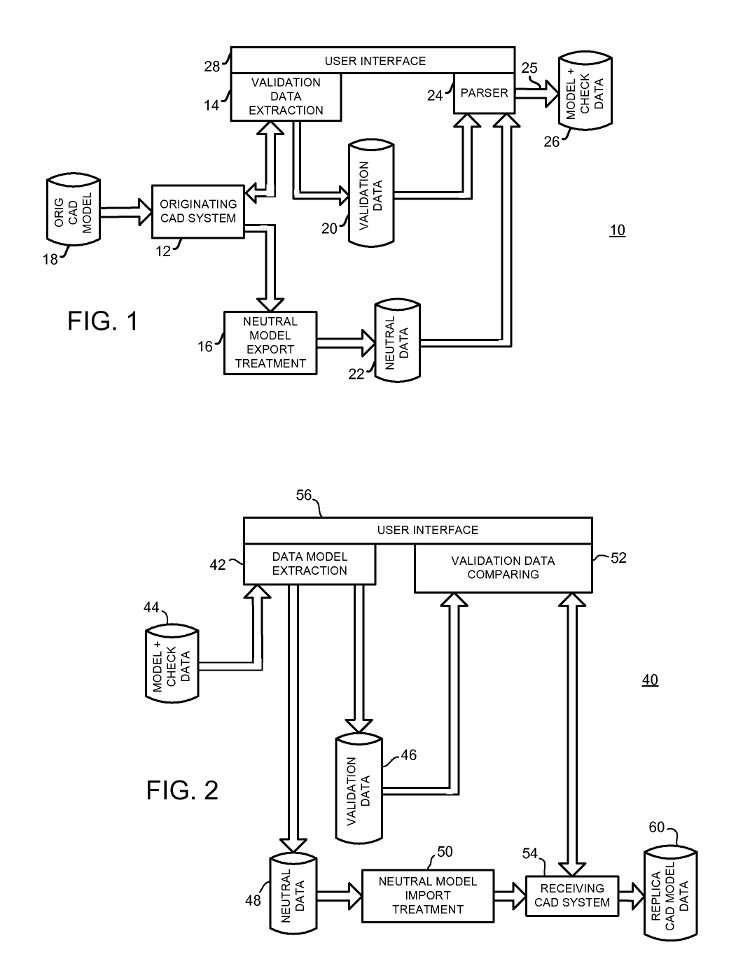

FIG. 1 is a schematic of a writer unit configured for use with embodiments of the system of the disclosure. In FIG. 1, a writer unit 10 may include an originating computer-interpretable graphic system 12, a validation data extraction unit 14 and a neutral model export treatment unit 16. In the exemplary writer unit 10 illustrated in FIG. 1, the originating computer-interpretable graphic system may be embodied in an originating CAD system 12. Originating CAD system 12 may receive CAD model data from an original CAD model data file 18. Validation data extraction unit 14 may cooperate with originating CAD system 12 to generate validation data relating to an original CAD model and present the validation data in a validation data file 20. Neutral model export treatment unit 16 may cooperate with originating CAD system 12 to generate neutral data (e.g., by way of example and not by way of limitation, a STEP file) relating to the original CAD model and present the neutral data in a neutral data file 22.

A parser unit 24 may receive and combine validation data from validation data file 20 with neutral data from neutral data file 22 to present a unified data signal (indicated by an arrow 25) to a model+check data file 26. For purposes of this description, a parser unit may be a unit that receives one or more inputs and presents contents of the received inputs in a predetermined format appropriately formatted for use by another system, unit or other entity. By way of example and not by way of limitation, output presentation from a parser may be configured in a packetized format, a serial format, a parallel format, an XML (eXtensible Markup Language) format or another format usable by another system, unit or other entity. A second computer-interpretable graphic system such as, by way of example and not by way of limitation, a receiving reader unit employing a replica CAD system (not shown in FIG. 1; see FIG. 2) may employ data contained in model+check data file 26 to generate a replica three-dimensional model or other graphic presentation substantially copying an original three-dimensional model or other graphic representation represented by data in an original CAD model embodied in data in original CAD model data file 18. In a preferred embodiment, model+check data file 26 may contain neutral data, validation data, control parameters and user-specified responses to queries posed to the user by one or the other or both of parser unit 24 and validation data extraction unit 14.

A user interface unit 28 may permit a user access to validation data extraction unit 14, parser unit 24 or to other units in writer unit 10 (connections not shown in detail in FIG. 1). One exemplary use for user interface unit 28 may be to permit a user to contribute user-specified criteria as a part of the validation data included in validation data file 20, adding validation data or other criteria using parser unit 24 or otherwise participating in the operation of writer unit 10.

A prior art approach to CAD file sharing and replica three-dimensional model presentation may require that the original and replica CAD systems be present on the same computer. In contrast, embodiments of the disclosure may introduce a packaged file where the neutral CAD data may be bundled with the validation data and may be verified at the receiving computer where the replica CAD system resides (receiving computer not shown in FIG. 1).

Embodiments of the disclosure may perform enforcement of data to engineering standards by checking a resulting target or replica model against validation parameters and only allowing a user to access the replica model data if the validation parameters are met or satisfied. In such an arrangement, validation parameters may be established to assure meeting of predetermined engineering criteria such as, by way of example and not by way of limitation, engineering tolerances.

In a preferred embodiment of the system and method of the disclosure, a meta-file may be packaged to include validation data or parameters with neutral geometric data of the sort that may be found in a STEP file.

Preferably verification in embodiments of the disclosure may be separated into a reading aspect and a writing aspect. By such separation, verification parameters may be established at an original CAD system and a process of verification of data may be performed at a target or replica CAD system using verification parameters provided with CAD neutral data (e.g., a STEP file). The establishing of verification parameters and the performance of verification using the verification parameters do not need to be carried out simultaneously.

Embodiments of the disclosure may permit streamlined transfer of verified graphic presentations such as drawings or design models from originating CAD programs to replica-producing CAD programs. Errors in replicas may be detected early on before a user of a replica drawing or model begins fabrication or some other operation based on the replica model. Collaboration may be significantly improved by embodiments of the disclosure improving accuracy among various entities using different CAD programs to address a common situation, product or process.

The preferred embodiment of the disclosure may facilitate conversion and validation of a CAD model from a source or original CAD system to a target or replica CAD system and enforce model criteria so that users may not use a replica CAD model generated by the target or replica CAD system if the criteria are not met.

To generate the verifiable geometry for generating a replica graphic presentation writer unit 10 may be employed either within an originating CAD system or externally of an originating CAD system. Writer unit 10 may prompt a user to input verification parameters or requirements via user interface unit 28. Writer unit 10 may also prompt a user to input other user-definable parameters via user interface unit 28. Writer unit 10 may extract the verification data to a second computer program (not shown in FIG. 1). After extracting all verification data writer unit 10 may generate neutral CAD data for storage in neutral data file 22. Depending on configuration of the participating originating and replica CAD programs, writer unit 10 may generate neutral data using one or more neutral formats. Parsing unit 24 may package all of the necessary data in preparation for distributing neutral data and verification and other parameters to model+check data file 26 for use by a replica CAD program.

FIG. 2 is a schematic of a reader unit configured for use with embodiments of the system of the disclosure. In FIG. 2, a reader unit 40 may include a data model extraction unit 42 configured and coupled for receiving data from a model+check data file 44 relating to a received computer-interpretable graphic model. In the illustrative embodiment of reader unit 40 illustrated in FIG. 2, the received computer-interpretable graphic model is embodied in a received CAD model. In a preferred embodiment, model+check data file 44 may provide data from a providing writer unit (not shown in FIG. 2; see, for example, writer unit 10; FIG. 1) including neutral data, validation data, control parameters and user-specified responses to queries posed to a user of the providing writer unit. Data in model+check data file 44 is preferably sufficient to permit reader unit 40 to substantially reproduce a three-dimensional model provided from a providing writer unit accurate within predetermined limits established by the providing writer unit. The predetermined limits may be expressed in terms of validation data provided by the providing writer unit to model+check data file 44.

Data model extraction unit 42 may extract validation data relating to the received CAD model represented by data received from model+check data file 44 and present the validation data for storage in a validation data file 46. Data model extraction unit 42 may also extract neutral data relating to the received CAD model represented by data received from model+check data file 44 and present the neutral data for storage in a neutral data file 48. Neutral data may be stored in neutral data file 48, by way of example and not by way of limitation, in a STEP file relating to the received CAD model received from model+check data file 44.

A validation data comparing unit 52 may be coupled with validation data file 46 and with a receiving graphic system 54. Receiving graphic system 54 in the exemplary reader unit 40 illustrated in FIG. 2 may be embodied in a receiving CAD system 54. Receiving CAD system 54 may be also coupled with neutral model import treatment unit 50. A user interface unit 56 may be coupled for communicating with at least data model extracting unit 42 and validation data comparing unit 52. Validation data comparing unit 52 may receive validation data from validation data file 46 to compare validation data with predetermined parameters. The predetermined parameters may be programmed into or otherwise resident in validation data comparing unit 52, may have been provided to validation data comparing unit 52 via a user interface unit 56, may have been introduced by user interface unit 56 via communication with data model extracting unit 42 or may otherwise be available for comparison with validation data received from validation data file 46.

In a preferred embodiment of reader system 40, if certain predetermined comparisons are not satisfactorily effected by validation data comparing unit 52, reader unit 40 may cease operation and proceed no further with reproducing a three-dimensional model represented by data received from model+check data file 44. Comparisons of similar decision making import and result may also or instead be effected using data model extracting unit 42 vis-á-vis data received from model+check data file 44.

If comparisons carried out by one or both of validation data comparing unit 52 and data model extracting 42 are satisfactorily completed, validation data comparing unit 52 may present checked validation data to receiving CAD system 54 in a format appropriate for use by receiving CAD system 54. Neutral model import treatment unit 50 may receive neutral data from neutral data file 48 for import-treatment to fashion import-treated neutral data in a format appropriate for use by receiving CAD system 54. Neutral model import treatment unit 50 may present import-treated neutral data to receiving CAD system 54.

Receiving CAD system 54 may employ checked validation data from validation data comparing unit 52 and import-treated neutral data from neutral model import treatment unit 50 to generate data for use in creating a replica computer-interpretable graphic model. The replica computer-interpretable graphic model produced by illustrative reader unit 10 in FIG. 2 may be embodied in a replica CAD model represented in a replica CAD model data file 60.

Reader unit 40 may open a received CAD model data file 60. Reader unit 40 may unpack the received CAD model data file 60 using a model extractor utility program in data model extracting unit 42 (not shown in detail in FIG. 2). Neutral format or formats data may be read into the receiving CAD system 54 via neutral data file 48 and neutral model import treatment unit 50. Validation data comparing unit 52 may interrogate a resulting replica model geometry generated by receiving CAD system 54 using one or more neutral formatted data sets. User interface 56 preferably may display results of the conversion and verification checking process performed by validation data comparing unit and receiving CAD system 54 for viewing by a user (not shown in FIG. 2). If the replica model represented by replica CAD model data generated by receiving CAD system 54 for storing in replica CAD model data file 60 is successfully converted within the predefined tolerances defined by validation data extracted from the original CAD model, user interface 56 may preferably present an option to a user to decide whether to save the resulting replica CAD data for storage in replica CAS model data file 60. If an out-of-tolerance condition is identified a user may be alerted and all replica CAD data files may be removed.

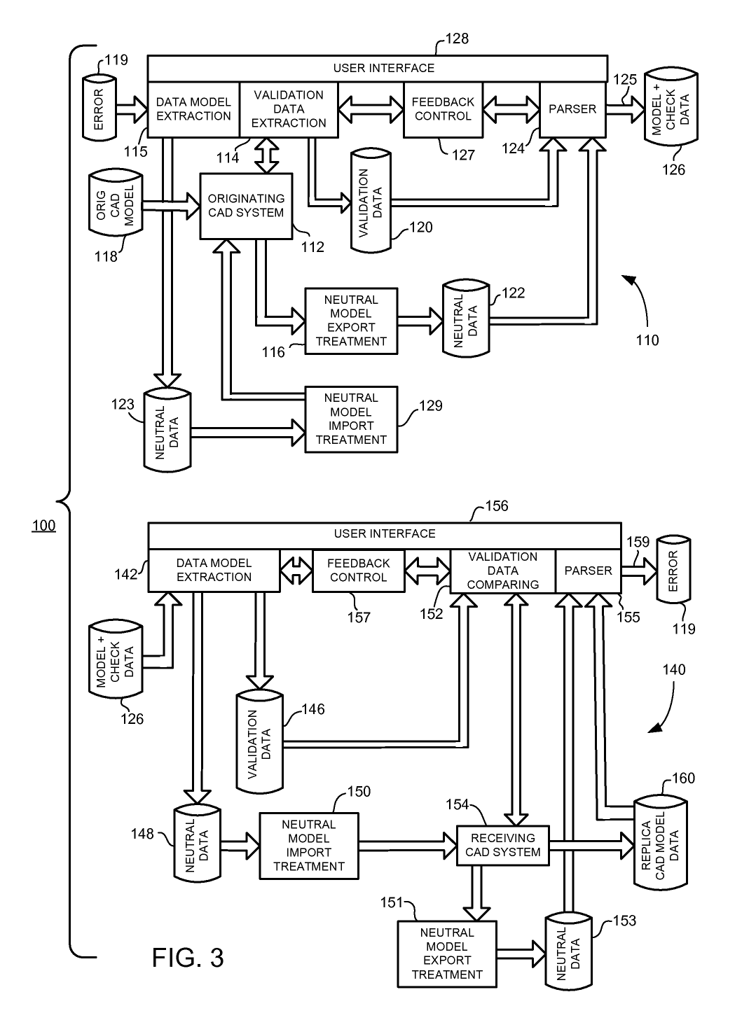

The implementation of the disclosure may incorporate a closed loop error feedback as described in connection with FIG. 3. Error feedback may be employed to enable an originator to approve conversion deviations or make translation or engineering changes to improve conversion results.

FIG. 3 is a schematic of a writer unit and a reader unit configured for use in troubleshooting embodiments of the system of the disclosure. In FIG. 3, a system 100 may include a writer unit 110 and a reader unit 140. An error data file 119 may be generated if an out-of-tolerance condition is identified by a user or by reader unit 140. Error data file 119 may contain data indicating the nature and scope and cause of the identified out-of-tolerance condition. Error data file 119 may be used by writer unit 110 to troubleshoot system 100 for purposes of identifying a cause or causes for the out-of-tolerance condition.

Writer unit 110 may include an originating computer-interpretable graphic system 112, a validation data extraction unit 114 and a neutral model export treatment unit 116. In the exemplary writer unit 110 illustrated in FIG. 3, the originating computer-interpretable graphic system may be embodied in an originating CAD system 112. Originating CAD system 112 may receive CAD model data from an original CAD model data file 118. Validation data extraction unit 114 may cooperate with originating CAD system 112 to generate validation data relating to an original CAD model and present the validation data in a validation data file 120. Neutral model export treatment unit 116 may cooperate with originating CAD system 112 to generate neutral data (e.g., by way of example and not by way of limitation, a STEP file) relating to the original CAD model and present the neutral data in a neutral data file 122.

A parser unit 124 may receive and combine validation data from validation data file 120 with neutral data from neutral data file 122 to present a unified data signal (indicated by an arrow 125) to a model+check data file 126. For purposes of this description, a parser unit may be a unit that receives one or more inputs and presents contents of the received inputs in a predetermined format appropriately formatted for use by another system, unit or other entity. By way of example and not by way of limitation, output presentation from a parser may be configured in a packetized format, a serial format, a parallel format, an XML (extensible Markup Language) format or another format usable by another system, unit or other entity. A second computer-interpretable graphic system such as, by way of example and not by way of limitation, a receiving or replica CAD system 154 may employ data contained in model+check data file 126 to generate a replica model or product definition or other graphic presentation substantially copying an original model or product definition or other graphic representation represented by data in an original CAD model embodied in data in original CAD model data file 118. In a preferred embodiment, model+check data file 126 may contain neutral data, validation data, control parameters and user-specified responses to queries posed to the user by one or the other or both of parser unit 124 and validation data extraction unit 114.

A user interface unit 128 may permit a user (not shown in detail in FIG. 3) access to validation data extraction unit 114, parser unit 124 or to other units in writer unit 110 (connections not shown in detail in FIG. 3). One exemplary use for user interface unit 128 may be to permit a user to contribute user-specified criteria as a part of the validation data included in validation data file 120, adding validation data or other criteria using parser unit 124 or otherwise participating in the operation of writer unit 110.

Writer unit 110 also may include a data model extraction unit 115 configured and coupled for receiving error data from error data file 119. Data model extraction unit 115 may be coupled for cooperation with validation data extraction unit 114 and coupled with a neutral data file 123. Neutral data file 123 may be coupled with a neutral model import treatment unit 129. Neutral model import treatment unit 129 may be coupled to provide feedback information relating to error data in error data file 119 to originating CAD system 112. A feedback unit 127 may be included in writer unit 110 coupled at least with validation extraction unit 114, parser unit 124 and user interface 128 to control operations of writer unit 110 in handling feedback error information received in error data file 119 from reader unit 140.

Reader unit 140 may include a data model extraction unit 142 configured and coupled for receiving data from model+check data file 126 (presented from writer unit 110) relating to a received computer-interpretable graphic model. In the illustrative embodiment of reader unit 140 illustrated in FIG. 3, the received computer-interpretable graphic model may be embodied in a received CAD model. In a preferred embodiment, model+check data file 126 may include neutral data, validation data, control parameters and user-specified responses to queries posed to a user of providing writer unit 110. Data in model+check data file 126 may preferably be sufficient to permit reader unit 140 to substantially reproduce a three-dimensional model provided from providing writer unit 110 accurate within predetermined limits established by providing writer unit 110. The predetermined limits may be expressed in terms of validation data provided by providing writer unit 110 to model+check data file 126.

Data model extraction unit 142 may extract validation data relating to the received CAD model represented by data received from model+check data file 126 and present the validation data for storage in a validation data file 146. Data model extraction unit 142 may also extract neutral data relating to the received CAD model represented by data received from model+check data file 126 and present the neutral data for storage in a neutral data file 148. Neutral data may be stored in neutral data file 148, by way of example and not by way of limitation, in a STEP file relating to the received CAD model received from model+check data file 126.

A validation data comparing unit 152 may be coupled with validation data file 146 and with a receiving graphic system 154. Receiving graphic system 154 in the exemplary reader unit 140 illustrated in FIG. 3 may be embodied in a receiving CAD system 154. Receiving CAD system 154 may be also coupled with neutral model import treatment unit 150. A user interface unit 156 may be coupled for communicating with at least data model extraction unit 142 and validation data comparing unit 152. Validation data comparing unit 152 may receive validation data from validation data file 146 to compare validation data with predetermined parameters. The predetermined parameters may programmed into or otherwise resident in validation data comparing unit 152, may have been provided to validation data comparing unit 152 via a user interface unit 156, may have been introduced by user interface unit 156 via communication with data model extracting unit 142 or may otherwise be available for comparison with validation data received from validation data file 146.

In a preferred embodiment of reader system 140, if certain predetermined comparisons are not satisfactorily effected by validation data comparing unit 152, reader unit 140 may cease operation and proceed no further with reproducing a model represented by data received from model+check data file 144. Comparisons of similar decision making import and result may also or instead be effected using data model extracting unit 142 vis-á-vis data received from model+check data file 144.

If comparisons carried out by one or both of validation data comparing unit 152 and data model extracting 142 are satisfactorily completed, validation data comparing unit 152 may present checked validation data to receiving CAD system 154 in a format appropriate for use by receiving CAD system 154. Neutral model import treatment unit 150 may receive neutral data from neutral data file 148 for import-treatment to fashion import-treated neutral data in a format appropriate for use by receiving CAD system 154. Neutral model import treatment unit 150 may present import-treated neutral data to receiving CAD system 154.

Receiving CAD system 154 may employ checked validation data from validation data comparing unit 152 and import-treated neutral data from neutral model import treatment unit 150 to generate data for use in creating a replica computer-interpretable graphic model. The replica computer-interpretable graphic model produced by illustrative reader unit 110 in FIG. 3 may be embodied in a replica CAD model represented in a replica CAD model data file 160.

Reader unit 140 also may include a neutral model export treatment unit 151 coupled with receiving CAD system 154. Neutral model export treatment unit 151 may be coupled with a neutral data file 153. Neutral data file 153 may be coupled with a parser unit 155. Parser unit 155 may be coupled with user interface 156, with validation comparing unit 152 and with replica CAD model data file 160. Parser unit 155 may present error data to error data file 119. A feedback unit 157 may be included in reader unit 140 coupled at least with data model extraction unit 142, validation data comparing unit 152 and user interface 156 to control operations of reader unit 140 in handling feedback error information presented to error data file 119.

Reader unit 140 may open a received CAD model data file 160. Reader unit 140 may unpack the received CAD model data file 160 using a model extractor utility program in data model extracting unit 142 (not shown in detail in FIG. 3). Neutral format or formats data may be read into the receiving CAD system 154 via neutral data file 148 and neutral model import treatment unit 150. Validation data comparing unit 152 may interrogate a resulting replica model geometry generated by receiving CAD system 154 using one or more neutral formatted data sets. User interface 156 may preferably display results of the conversion and verification checking process performed by validation data comparing unit and receiving CAD system 154 for viewing by a user (not shown in FIG. 3). If the replica model represented by replica CAD model data generated by receiving CAD system 154 for storing in replica CAD model data file 160 is successfully converted within the predefined tolerances defined by validation data extracted from the original CAD model, user interface 156 may preferably present an option to a user to decide whether to save the resulting replica CAD data for storage in replica CAS model data file 160. If an out-of-tolerance condition is identified a user may be alerted and all replica CAD data files may be removed.

Alternatively, a troubleshooting or similar operation may be employed to attempt to improve conversion of data for storing in replica CAD model data file 160 that is within the predefined tolerances defined by validation data extracted from original CAD model 118. In such a troubleshooting operation, rather than removing replica CAD data files, an error file 119 may be generated by a feedback loop including neutral model export treatment unit 151, neutral data file 153 and parser unit 159. Neutral model export treatment system 151 may receive data relating to the replica CAD model from receiving CAD system 154 and may present neutral data relating to the replica CAD model to neutral data file 153. Parser unit 155 may receive neutral data relating to the replica CAD model from neutral data file 153 and may receive replica CAD model data from replica CAD model data file 160. Parser unit 155 may receive and combine neutral data from neutral data file 153 and replica CAD model data from replica CAD model data file 160 to present a unified data signal (indicated by an arrow 159) to a error data file 119 indicating unsuccessfully converted replica CAD model data. Error data file 119 at least may contain errors in converted replica CAD data from replica CAD model data file 160 defined as errors vis-á-vis predefined tolerances defined by validation data extracted from original CAD model 118.

Error file 119 may be accessed by data model extraction unit 115 (in writer unit 110). Data model extraction unit 115 may extract neutral data relating to data in error file 119 and may present the extracted neutral data to neutral data file 123. Neutral model import treatment unit 129 may receive neutral data relating to the replica CAD model from neutral data file 123 and may present import-treated neutral data relating to the replica CAD model to originating CAD system 112. Validation data extraction unit 114 may cooperate with originating CAD system 112 to generate revised validation data relating to the replica CAD model and may present the revised validation data in validation data file 120. Neutral model export treatment unit 116 may cooperate with originating CAD system 112 to generate revised neutral data relating to the replica CAD model and may present the revised neutral data in neutral data file 122.

Parser unit 124 may receive and combine revised validation data from validation data file 120 with revised neutral data from neutral data file 122 to present a revised unified data signal (indicated by arrow 125) to model+check data file 126.

Reader unit 140 may employ data model extraction unit 142 for receiving revised data from model+check data file 126 to operate substantially as described above in order to present revised replica CAD model data at replica CAD model data file 160.

If the revised replica CAD model data in replica CAD model data file 160 is successfully converted within the predefined tolerances defined by validation data extracted from original CAD model 112, a user may decide whether to save the resulting revised replica CAD data. If an out-of-tolerance condition is identified a user may be alerted and all replica CAD data files may be removed, or a troubleshooting operation may be employed anew.

Thus, a closed loop error handling configuration may be established to enable creating a packaged error file 119. Preferably, error file 119 may contain at least indications relating to all error reports created by the conversion algorithms, target software identification, resulting geometry and any other available data pertinent to the failed conversion to replica CAD model data.

Error file 119 may be read into writer unit 110, and writer unit may present results of a failed conversion in a manner which permits a user, such as a design authority, to investigate the cause and impact of any error or other conversion deviation. By way of example and not by way of limitation, an engineering override approval may be granted so that a resulting replica model may be returned to a vendor that created the involved originating and replica CAD programs. Alternatively, additional engineering may be performed by operators and users to improve conversion results.

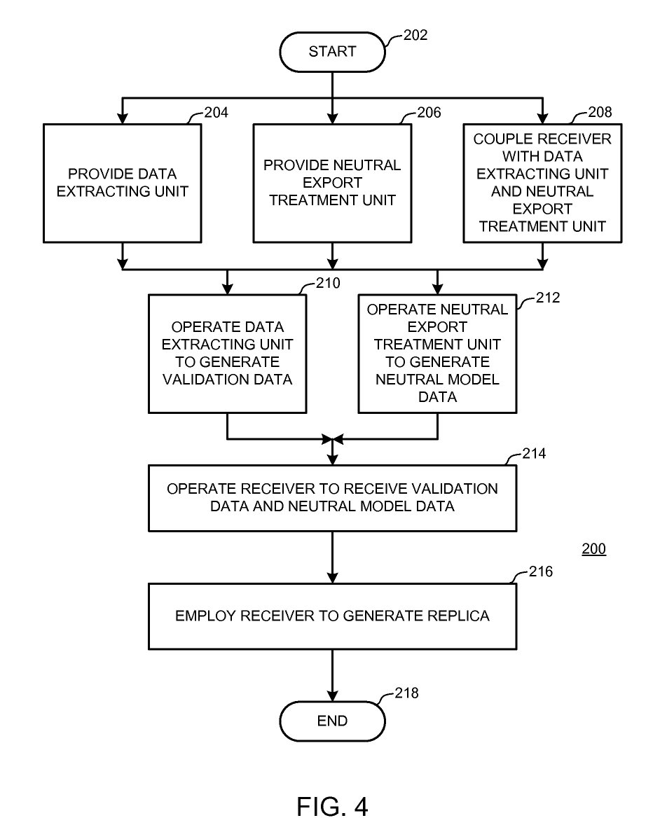

FIG. 4 is a flow diagram illustrating an embodiment of the method of the disclosure. In FIG. 4, a method 200 for providing a graphic presentation replica of an original graphic presentation begins at a START locus 202. The original graphic presentation is represented by an original graphic data set. The original graphic presentation is established by an originator employing the original graphic data set with a first graphic instruction set. Method 200 continues by, in no particular order: (1) providing a data extracting unit coupled for accessing the original graphic data set, as indicated by a block 204; (2) providing a neutral export treatment unit coupled for accessing the original graphic data set, as indicated by a block 206; and (3) coupling the receiver with the data extracting unit and with the neutral export treatment unit, as indicated by a block 208.

Method 200 continues by, in no particular order: (1) operating the data extracting unit to generate validation data defining at least one validation parameter for evaluating whether to accept at least one difference between the original graphic presentation and the graphic presentation replica, as indicated by a block 210; and (2) operating the neutral export treatment unit to generate neutral model data relating to the original graphic presentation, as indicated by a block 212. The neutral model data may be expressed in neutral terminology usable by a second graphic instruction set.

Method 200 continues by operating the receiver to receive the validation data and the neutral model data, as indicated by a block 214. Method 200 continues by employing the receiver to use the validation data and the neutral model data with the second graphic instruction set for generating the graphic presentation replica, as indicated by a block 216. The graphic presentation replica may be sufficiently similar with the original graphic presentation to satisfy at least one validation parameter of the at least one validation parameter. Method 200 terminates at an END locus 218.

It is to be understood that, while the detailed drawings and specific examples given describe preferred embodiments of the disclosure, they are for the purpose of illustration only, that the apparatus and method of the disclosure are not limited to the precise details and conditions disclosed and that various changes may be made therein without departing from the spirit of the disclosure which is defined by the following claims:

I claim:

1. A system for providing a graphic presentation replica of an original graphic presentation; said original graphic presentation being represented by an original graphic data set; said original graphic presentation being established by an originator employing said original graphic data set with a first graphic instruction set; the system comprising:
(a) a data extracting unit coupled for accessing said original graphic data set to generate validation data; said validation data defining at least one validation parameter for evaluating whether to accept at least one difference between said original graphic presentation and said graphic presentation replica; and
(b) a neutral export treatment unit coupled for accessing said original graphic data set to generate neutral model data relating to said original graphic presentation; said neutral model data being expressed in neutral terminology usable by a second graphic instruction set;
(c) a receiver coupled with said data extracting unit and with said neutral export treatment unit for receiving said validation data and said neutral model data; said receiver employing said validation data and said neutral model data for generating a translated graphic data set; said receiver establishing said graphic presentation replica employing said translated graphic data set using said second graphic instruction set; said graphic presentation replica being sufficiently similar with said original graphic presentation to satisfy at least one validation parameter of said at least one validation parameter.

2. A system for providing a graphic presentation replica of an original graphic presentation as recited in claim 1 wherein said data extracting unit includes a user input unit configured for receiving inputs from a user.

3. A system for providing a graphic presentation replica of an original graphic presentation as recited in claim 2 wherein said user inputs affect at least one validation parameter of said at least one validation parameter.

4. A system for providing a graphic presentation replica of an original graphic presentation as recited in claim 1 wherein said validation data is generated for presentation in a data file.

5. A system for providing a graphic presentation replica of an original graphic presentation as recited in claim 1 wherein said neutral model data is generated for presentation in data file.

6. A system for providing a graphic presentation replica of an original graphic presentation as recited in claim 3 wherein said validation data is generated for presentation in a data file.

7. A system for providing a graphic presentation replica of an original graphic presentation as recited in claim 3 wherein said neutral model data is generated for presentation in data file.

8. A system for providing a multi-dimensional model replica of an original multi-dimensional model; said original model being represented by an original multi-dimensional model data set; said original model being established by an originator employing said original multi-dimensional model data set with a first computer graphic program; the system comprising:
(a) a data extracting unit coupled for accessing said original multi-dimensional model data set to generate validation data; said validation data defining at least one validation parameter for evaluating whether to accept at least one difference between said original model and said model replica; and
(b) a neutral export treatment unit coupled for accessing said original model data set to generate neutral model data relating to said original multi-dimensional model; said neutral model data being expressed in neutral terminology usable by a second computer graphic program;
(c) a receiver coupled with said data extracting unit and with said neutral export treatment unit for receiving said validation data and said neutral model data; said receiver employing said validation data and said neutral model data for generating a translated model data set; said receiver establishing said model replica employing said translated model data set using said second computer graphic program; said model replica being sufficiently similar with said original model to satisfy at least one validation parameter of said at least one validation parameter.

9. A system for providing a multi-dimensional model replica of an original multi-dimensional model as recited in claim 8 wherein said data extracting unit includes a user input unit configured for receiving inputs from a user.

10. A system for providing a multi-dimensional model replica of an original multi-dimensional model as recited in claim 9 wherein said user inputs affect at least one validation parameter of said at least one validation parameter.

11. A system for providing a multi-dimensional model replica of an original multi-dimensional model recited in claim 8 wherein said validation data is generated for presentation in a data file.

12. A system for providing a multi-dimensional model replica of an original multi-dimensional model as recited in claim 8 wherein said neutral model data is generated for presentation in data file.

13. A system for providing a multi-dimensional model replica of an original multi-dimensional model as recited in claim 10 wherein said validation data is generated for presentation in a data file.

14. A system for providing a multi-dimensional model replica of an original multi-dimensional model as recited in claim 10 wherein said neutral model data is generated for presentation in data file.

15. A method for providing a graphic presentation replica of an original graphic presentation; said original graphic presentation being represented by an original graphic data set; said original graphic presentation being established by an originator employing said original graphic data set with a first graphic instruction set; the method comprising:
(a) in no particular order:
(1) providing a data extracting unit coupled for accessing said original graphic data set;
(2) providing a neutral export treatment unit coupled for accessing said original graphic data set; and
(3) coupling said receiver with said data extracting unit and with said neutral export treatment unit;
(b) in no particular order:
(1) operating said data extracting unit to generate validation data defining at least one validation parameter for evaluating whether to accept at least one difference between said original graphic presentation and said graphic presentation replica; and
(2) operating said neutral export treatment unit to generate neutral model data relating to said original graphic presentation; said neutral model data being expressed in neutral terminology usable by a second graphic instruction set;
(c) operating said receiver to receive said validation data and said neutral model data; and
(d) employing said receiver to use said validation data and said neutral model data with said second graphic instruction set for generating said graphic presentation replica; said graphic presentation replica being substantially sufficiently similar with said original graphic presentation to satisfy at least one validation parameter of said at least one validation parameter.

16. A method for providing a graphic presentation replica of an original graphic presentation as recited in claim 15 wherein said data extracting unit includes a user input unit configured for receiving inputs from a user.

17. A method for providing a graphic presentation replica of an original graphic presentation as recited in claim 16 wherein said user inputs affect at least one validation parameter of said at least one validation parameter.

18. A method for providing a graphic presentation replica of an original graphic presentation as recited in claim 15 wherein said validation data is generated for presentation in a data file.

19. A method for providing a graphic presentation replica of an original graphic presentation as recited in claim 15 wherein said neutral model data is generated for presentation in data file.

20. A method for providing a graphic presentation replica of an original graphic presentation as recited in claim 3 wherein said validation data is generated for presentation in a data file, and wherein said neutral model data is generated for presentation in data file.
